(19) United States
(12) Patent Application Publication
(10) Pub. No.: US 2026/0087387 A1
(43) Pub. Date: Mar. 26, 2026

(54) Transactional Neural Reasoning AI (TNRAI)

(71) Applicant: Joshua B Williamson, Humble, TX (US)

(72) Inventor: Joshua B Williamson, Humble, TX (US)

(21) Appl. No.: 19/171,498

(22) Filed: Apr. 7, 2025

(51) Int. Cl. G06N 5/043; G06F 8/71

(52) U.S. Cl. CPC G06N 5/043; G06F 8/71

(57) ABSTRACT

Transactional Neural Reasoning AI (TNRAI) is a novel class of artificial intelligence designed to simulate human-like reasoning during live, multimodal user sessions. TNRAI departs from traditional static inference models by integrating a five-pillar architecture: (1) delta-path modeling for real-time outcome deviation detection, (2) skew-based adversarial recognition, (3) vector memory recall for behavioral context, (4) ambient reasoning overlays to incorporate situational data, and (5) a multi-logic arbitration engine that fuses rule-based, statistical, situational, and historical reasoning. The system evolves continuously via a CI/CD feedback loop, adjusting its logic and thresholds based on live outcomes. TNRAI supports overlays such as time or location constraints to influence reasoning and can activate conditional triggers based on logic patterns or confidence thresholds. This architecture enables adaptive, deliberative decision-making in real time, extending the utility of AI across domains such as automation, compliance enforcement, customer engagement, and transaction-based system control.

### 4. DESCRIPTION OF DRAWINGS

FIG. 0: Core Architecture of TNRAI: Five-Pillar Deliberation Framework illustrates the foundational architecture of the Transactional Neural Reasoning AI (TNRAI) system. The design simulates human-like deliberation by combining five core engines:
Delta-Path Model—Predicts ideal session outcomes and computes real-time deviation (deltas) to evaluate trajectory toward success.
Skew-Based Adversarial Model—Monitors for fraud, contradiction, or high-risk behavior using learned failure patterns and anomaly signals.
Vector Memory Engine—Encodes historical, behavioral, and contextual user data into high-dimensional embeddings for live recall and pattern matching.
Ambient Context Processor—Ingests environmental data (e.g., time, weather, events, load) and injects non-obvious overlays into decision pathways.
Multi-Logic Arbitration Engine—Executes a deliberative logic model that integrates multiple concurrent reasoning types (conditional, statistical, situational, historical, ambient) to form a unified decision output.

These components interact in real time and feed their outputs to an Actionable Logic Layer, which selects and executes next actions, responses, or protocol escalations.

Session outcomes are continuously monitored and routed through a CI/CD feedback pipeline, enabling the system to evolve dynamically over time. This architecture constitutes a novel class of AI

FIG. 1: Transactional Neural Reasoning AI Application design

Presents the core system architecture for the Transactional Neural Reasoning AI, highlighting how internal and external data sources converge into a continuous reasoning cycle that informs and adapts user interactions in real time.

FIG. 2: Intent Vector Flow

Shows how inputs are converted into vectorized memory, which is subsequently used for user intent inference and modified by behavioral or biometric overlays to generate derived logic used in session decisions.

FIG. 3: Confidence-Based Fallback Logic

Illustrates a continuous integration and deployment loop used within the TNRAI system, wherein session data informs outcome tracking, feeding into a model testing, retraining, and redeployment pipeline that loops back to influence ongoing decision models.

FIG. 4: Delta Path Modeling

shows the delta computation process in a neural network. After processing training data via forward feeding, the network calculates loss and determines weight adjustments based on deltas from ideal outcomes, reinforcing or adjusting logic parameters.

FIG. 5: Skew Based Detection

Illustrates the injection of ambient data—processed by an ambient context module—into parallel logic paths within the TNRAI reasoning engine, contributing to output generation based on external contextual influence.

FIG. 6: Ambient Based Context

Illustrates how static values and user-driven inputs are augmented by contextual overlays—such as market activity, weather, and time of day—to produce a reason-weighted navigation output. This output dynamically selects and prioritizes among various logic branches, including conditional, learned, statistical, and predictive logic modules, to guide transactional decisions.

FIG. 7: Conditional Triggers

illustrates the decision cycle within the TNRAI engine. When an event trigger is detected, the system conducts engagement analysis to determine user intent and subsequently generates a contextually appropriate response.

FIG. 8: Multiple Logic Reasoning

represents a predictive confidence scoring and escalation flow, specifically tied to consent logic and agent deflection based on TNRAI's assessment. This aligns closely with Claim 11, which discusses how the system initiates workflows when it detects low confidence or uncertainty in the user's ability to give informed consent.

FIG. 9: Action Feedback Loops

Illustrates the injection of ambient data—processed by an ambient context module—into parallel logic paths within the TNRAI reasoning engine, contributing to output generation based on external contextual influence.

FIG. 10: Full Transactional Loop

Depicts the dialectical reasoning loop—Thesis, Antithesis, and Synthesis—which serves as a conceptual model for reconciliation of competing logic streams in the TNRAI architecture.

FIG. 11: Applied Logic Flow

illustrates the structured relationship between diverse reasoning logic modules, data sources, actionable logic components, and alternative decision pathways. The diagram emphasizes the layered approach TNRAI uses to evaluate, synthesize, and refine logic for real-time transactional AI decisions.

FIG. 12: AI Guided Agent to Conversion

Illustrates a buyer with intent, interaction to conversion between the TRNAIG and agent working off of contextually adjusting perceived factors until it reaches High Confidence based on the

### 5. FIELD OF THE INVENTION

The present invention relates to artificial intelligence systems and, more specifically, to a novel class of AI termed Transactional Neural Reasoning AI (TNRAI). This class introduces a human-like deliberation framework to AI by leveraging a five-pillar architecture that enables real-time reasoning, contextual awareness, and adaptive logic during ongoing user interactions. Unlike conventional machine learning models or static logic systems, TNRAI continuously evaluates user behavior and environmental context through:
Delta-path modeling, which compares ongoing interaction trajectories to idealized goal paths,
Skew-based adversarial resilience, which detects known failure and fraud patterns in-session,
Vector memory recall, which allows high-dimensional behavioral and contextual recall during decision cycles,
Ambient reasoning overlays, which modulate decisions using situational data (e.g., location, weather, systemic stressors), and
Multi-logic arbitration engines, which integrate and reconcile multiple concurrent reasoning paradigms into a unified decision.

These elements collectively simulate human-like cognition by dynamically weighting reasoning paths, detecting divergence or deception, and evolving decisions through real-time CI/CD feedback loops. This invention defines a new AI class focused not on predictive inference alone but on transactional reasoning —enabling machines to deliberate, adapt, and optimize outcomes within live interactions across diverse domains.

### 6. FIELD OF THE INVENTION

The present invention relates to artificial intelligence systems and, more specifically, to a novel class of AI termed Transactional Neural Reasoning AI (TNRAI). This class introduces a human-like deliberation framework to AI by leveraging a five-pillar architecture that enables real-time reasoning, contextual awareness, and adaptive logic during ongoing user interactions. Unlike conventional machine learning models or static logic systems, TNRAI continuously evaluates user behavior and environmental context through:
Delta-path modeling, which compares ongoing interaction trajectories to idealized goal paths,
Skew-based adversarial resilience, which detects known failure and fraud patterns in-session,
Vector memory recall, which allows high-dimensional behavioral and contextual recall during decision cycles,
Ambient reasoning overlays, which modulate decisions using situational data (e.g., location, weather, systemic stressors), and
Multi-logic arbitration engines, which integrate and reconcile multiple concurrent reasoning paradigms into a unified decision.

These elements collectively simulate human-like cognition by dynamically weighting reasoning paths, detecting divergence or deception, and evolving decisions through real-time CI/CD feedback loops. This invention defines a new AI class focused not on predictive inference alone but on transactional reasoning—enabling machines to deliberate, adapt, and optimize outcomes within live interactions across diverse domains.

### 7. DESCRIPTION OF PRIOR ART

Traditional AI inference engines and intent classifiers handle narrow tasks and often lack comprehensive contextual reasoning. For example, rule-based reasoning engines have been used to draw conclusions from environmental data or known facts, but typically rely on a single type of logic or pre-defined rules.

Conventional conversational AI systems (chatbots) can derive an intent vector from a user's input and map it to probable intents, triggering a response if a confidence threshold is met. One such system uses a trigger control model (e.g. a logistic regression) to decide whether a chatbot should respond, based on the user's query and engagement context. Separately, predictive routing engines in contact centers combine business rules with statistical models to route customers to the best resource and adapt over time using outcome feedback (e.g. adjusting models when a call outcome is successful).

Additionally, specialized machine learning pipelines have been developed for generating and deploying models, but these are often offline or require manual intervention for each update.

While these prior approaches each address an aspect of intelligent decision-making, they operate in isolation. Intent classifiers focus on immediate input-output mapping and lack deeper reasoning or memory. Rule-based expert systems and reasoning engines can apply logic but do not learn from outcomes in real-time, and their use of context is limited. Continuous integration of new data into model updates (often referred to in MLOps) is rarely tied directly into the inference loop for live sessions. Moreover, conventional AI systems generally do not combine ideal outcome path modeling with adversarial case handling simultaneously. For instance, adversarial training of neural networks is known to improve robustness against small input perturbations, but this technique is typically applied during offline training rather than as a concurrent modeling stream in live reasoning. Similarly, context-aware recommendation systems can adjust outputs based on time, location or weather, but such ambient data is not usually woven into a unified, real-time decision engine alongside user-specific behavioral memory.

In summary, the prior art lacks a cohesive AI engine that: (1) maintains a vectorized memory of session interactions to derive user intent in real time; (2) continuously tests and updates its predictive models during operation; (3) uses a dual modeling approach with delta-based “ideal path” predictions and skew-based adversarial patterns for robust outcome prediction; (4) leverages ambient context (time, weather, etc.) to influence decisions; and (5) integrates multiple reasoning logics with conditional triggers to take or recommend actions. The Transactional Neural Reasoning AI (TNRAI) described in this invention fills this gap by combining all these elements into a single, novel system.

### 8. SUMMARY OF THE INVENTION

The invention is a Transactional Neural Reasoning AI (TNRAI) platform that introduces an integrated approach to session-based intelligence and decision automation. TNRAI fundamentally differs from traditional machine learning inference or NLP intent classifiers by treating each user session or transaction as a dynamic “transaction” that can be reasoned about, tested, and steered towards an optimal outcome in real time.

In one aspect, the TNRAI system builds and maintains a vector-based memory of interactions. As users engage (via voice, text, clicks, or other modalities), TNRAI captures direct interaction data, relevant historical records, and behavioral signals, encoding them into a session vector or set of vectors. These vectors, stored in a vector memory, represent the context and inferred intent state of the ongoing session. Using this contextual memory, TNRAI performs real-time intent derivation—essentially computing an “intent vector” that reflects the probabilities or weights of various possible intents or goals of the user. Unlike static intent classification, this derivation continuously updates as the session progresses, referencing both immediate inputs and historical behavioral patterns (for example, past purchases or prior queries) to refine understanding.

Another aspect of TNRAI is its continuous outcome testing and model integration pipeline. The system includes an automated CI/CD (Continuous Integration/Continuous Deployment) pipeline for its internal models and logic rules. As new vector data is generated during each session, TNRAI evaluates the outcomes of its decisions (e.g., whether a suggested action led to a successful result) and feeds this data back into model updates. These updates occur through a live pipeline of testing and deployment—for instance, TNRAI might run A/B tests or shadow evaluations of new logic versions on incoming session data. If a new model or rule set shows improved performance on recent outcomes, the system can seamlessly deploy it, thereby evolving its decision-making policy in near real time. This continuous learning loop ensures that TNRAI adapts quickly to changing user behaviors or environmental conditions, without waiting for offline retraining cycles.

TNRAI's predictive capabilities are enhanced by a dual modeling approach: delta-based ideal path modeling and skew-based adversarial modeling. The delta-based model component generates an “ideal path” for a session—i.e., an optimal sequence of user-system interactions predicted to achieve the desired outcome (such as a successful transaction or problem resolution). By comparing the actual session trajectory to this ideal path, TNRAI computes a set of delta features representing the deviation between the current behavior and the optimal behavior. These delta values help the system gauge how far off-course a session might be and predict the likelihood of achieving the desired outcome if no intervention occurs. In parallel, the skew-based model component is trained on adversarial, misleading, or failed session data (the “corner cases”) to recognize patterns that typically lead to undesired outcomes. This adversarial trained sub-model acts as an anomaly or risk detector within TNRAI, raising flags or adjusting confidence when the current session exhibits characteristics like known failure patterns.

Together, the ideal-path delta model and the skew-based adversarial model allow TNRAI to predict outcomes with greater accuracy and robustness: the ideal-path model drives the system toward success by knowing what should happen, while the skew model safeguards the system by recognizing what should not happen.

In addition to user-derived data, TNRAI incorporates ambient reasoning using contextual data that is not provided directly by the user. This may include temporal data (time of day, day of week), environmental data (weather, local events), locational data, or system state data. These ambient factors are used to modulate the decision weights in TNRAI's reasoning process. For example, TNRAI might give additional weight to certain user intents during business hours versus late at night, or might alter its dialogue strategy if it detects inclement weather in the user's region (indicating the user could be in a hurry or distressed). Ambient context has been recognized in prior systems (e.g., using weather or location to tailor recommendations), but TNRAI uniquely folds this data into its internal reasoning engine, allowing indirect context to subtly influence outcomes (this is referred to as ambient reasoning). By considering non-obvious signals (like a spike in local activity or background device usage patterns), TNRAI achieves a more holistic understanding of the situation, akin to a human's intuition based on surroundings.

The heart of TNRAI is a multi-modal reasoning engine that processes inputs through multiple internal logic types and synthesizes the results. Specifically, TNRAI's reasoning engine comprises a suite of sub-engines or logic units, each specialized in a particular form of reasoning: (1) Conditional logic—applying if-then rules or decision trees; (2) Mathematical reasoning—performing quantitative calculations or evaluations (e.g., scoring, thresholding); (3) Statistical inference—drawing probabilistic conclusions from data patterns; (4) Ambient context analysis—interpreting external context signals as described; (5) Situational (dynamic) analysis—evaluating the current state of the session (e.g., how long the user has been engaged, recent actions); and (6) Historical pattern matching—leveraging past session outcomes or known user history to inform the current decision. These diverse reasoning approaches run in parallel, or sequence as needed, and the engine combines their outputs to form a cohesive next action or decision. This design is inspired in part by cognitive architecture and expert systems that allow multiple inference methods; however, TNRAI's engine is novel in its breadth of logic types and tight integration with the other components (memory, ambient data, outcome feedback, etc.). The result is an AI that can, for example, use strict rule-based reasoning for compliance checks, while simultaneously using statistical prediction for user intent, and checking an ambient context condition—all contributing to the final decision.

Finally, TNRAI includes an actionable logic engine that sits atop the reasoning outputs. This component is responsible for translating TNRAI's inferences and predictions into real-world action or responses. It applies derived rules (which may be dynamically generated by the reasoning engine), verifies predicted outcomes, and can also consider operator-defined alternatives or constraints (for cases where a human expert has provided specific guidance or rules). The actionable logic engine essentially decides what to do next—for instance, should the system ask the user a clarifying question, execute a transaction, invoke a safety protocol, or hand over control to a human operator. It uses the rich insight from TNRAI's reasoning to choose an action that is most likely to achieve the desired outcome. Importantly, this engine can also perform continuous testing of its actions. TNRAI monitors whether the actions taken indeed lead to successful outcomes and feeds that information back (closing the loop via the continuous integration pipeline). Over time, the actionable logic engine may update its rule set or selection strategy. This approach differs from static action selection in traditional chatbots or rule systems; for example, prior call routing systems had fixed rule+model combinations to decide routing, whereas TNRAI's action engine evolves through experience, creating a more legally defensible and adaptive framework for automated decision-making.

In summary, TNRAI provides a completely new class of AI that unifies real-time vectorized intent memory, continuous model CI/CD, ideal-path vs. adversarial outcome modeling, ambient context integration, multi-form reasoning, and dynamic action execution. This yields an AI engine capable of transactional reasoning—it treats each session as a transaction to be optimized and completed with reasoning akin to human-level deliberation. TNRAI's architecture ensures technical advantages (like resilience to adversarial inputs and quick adaptability) and a clear differentiation from existing AI approaches that are either purely predictive (black-box models) or purely procedural (static rules). By combining these elements, TNRAI can provide context-rich, outcome-driven interactions in domains such as intelligent virtual assistants, session-based media controllers, autonomous customer service agents, and other systems requiring real-time reasoning and decision automation.

### 9. GLOSSARY OF TERMS

### 1. Transactional Neural Reasoning AI (TNRAI)

A novel AI class that reasons across multiple rationale points and logic flows to derive user intent and predict session outcomes in real time with high accuracy and regularity based on continuous pipeline training, and treating every log file and event as business intelligence good, bad or ugly. Unlike traditional intent classifiers or statistical models, TNRAI combines rules based, conditional, and scores based contextual memory, continuous learns and improves, introduces ambient reasoning, and delta/skew modeling into a unified decision engine with actionable events and escalation patterns, as well as intent and path to desired outcome based execution.

### 2. Vector Memory

A structured store of high-dimensional embeddings derived from live and historical session data. Used to inform real-time intent interpretation, behavior prediction, and outcome scoring in a format suitable for high speed algorithmic processing in a CI/CD pipeline runner.

### 3. Intent Vector

A numerical representation of the user's inferred goals during any interaction session, this can be statically defined, reasonably derived, or a value derived from quizzing the intent of the responsible party over the AI engine, and this can be dynamically updated as contextual or behavioral data evolves, with notifications of changes allowing the AI engine to grow but do so in a calculated and ideal manner.

### 4. Delta-based Modeling

A method for comparing a user's current session path against an ideal path and computing deviation (delta) metrics to assess the likelihood of success or to use as an indicator as to the degree of failure in an exercise. Having a perfect model set is crucial to the success of the TNRAI engine.

### 5. Skew Modeling

The use of adversarial or failure-pattern data to recognize risk conditions and inject cautionary weighting into the system's reasoning pipeline, by having designed failures or guaranteed failure logic introduced routinely, the predictive, path to success, neural reasoning and on the fly ability to adapt to a changing engagement without setting itself up to fail. It is always adjusting based on the best and worst possible outcome to find a path to a desired outcome.

### 6. Ambient Context

External data not directly related to the data flow in progress but when introduced as an overlay has potential to affect outcome. (e.g., time of day, location, weather, local events) used to inform decisions through environmental awareness.

### 7. CI/CD Pipeline

An automated process for training, testing, and deploying new models and logic in real time, allowing the system to evolve continuously with fresh input data. All transactions, engagements, calls, interactions no matter the outcome become training instructions which are processed across every available condition to determine all possible outcomes, best possible outcome, worst possible outcome, all of which are assigned risk scores, cataloged and become usable intelligence.

### 8. Multi-Logic Reasoning Engine

The central logic system is comprised of conditional logic, statistical inference, mathematical modeling, historical case retrieval, ambient interpretation, and situational analysis, this can be further extended for specific use cases by adding plugins build to empower the model.

### 9. Conditional Trigger Engine

A system component that monitors session metrics and activates logic branches or security responses when defined conditions are met, and can create chained events based on further conditions.

### 10. Actionable Logic Engine

Executes decisions based on the output of the reasoning engine, including rule validation, action scoring, operator-guided alternatives, and continuous performance feedback, historically identical engagements, and derived paths of outcome with score-based probabilities to determine the engagement value

### 11. Ideal Path

A precomputed or learned optimal sequence of steps that when predicted and responses are favorable will lead to a successful task or desired outcome.

### 12. Adversarial Pattern

A historical or inferred interaction pattern correlated with failure, fraud, or low confidence outcomes, used for risk analysis and mitigation.

### 13. Feedback Loop

A closed loop where the outcome of each system action is recorded and used to retrain or refine future reasoning and decision processes, and by learning of success/failure events on transactions the model can attribute speech, movement, eye behavior, body movement, tone, speech cadence, hesitations and other human factors into data points which it can derive predictions with high accuracy, and determine misleading queues and intentional gaming of the model through routine testing, learning and strong statistical data backing.

### 14. Real Time Arbitration

The process by which TNRAI evaluates outputs from multiple concurrent logic engines—including rule-based, statistical, situational, ambient, and historical systems—within the bounds of a live, ongoing user session. Arbitration is performed continuously and adaptively, producing a single synthesized decision output that reflects the weighted interplay of divergent logic paths. Unlike offline model voting or static rule prioritization, real-time arbitration is dynamic and context-sensitive, mirroring human-like deliberation across competing reasoning strategies.

### 15. Session Trajectory Similarity

A vectorized measurement of how closely a current session aligns with a previously defined or idealized behavioral path. This similarity is computed using vector memory recall in combination with delta-based modeling to detect session drift, engagement breakdowns, or contextual mismatches. The session trajectory similarity metric enables the TNRAI system to preemptively adjust decisions or escalate interventions before a failure occurs. This term supports both session grading and live engagement strategy modulation.

### 16. Outcome Forecasting Mode

A probabilistic logic layer that projects the likelihood of various session outcomes based on current interaction patterns, contextual overlays, and historical data. This model operates alongside delta-path tracking to anticipate successful or degraded paths and allows TNRAI to steer engagement toward the most favorable resolution. The forecasting model is updated continuously by the CI/CD pipeline and is used to refine ideal path mapping and outcome expectation weights across future sessions.

### 9. DETAILED DESCRIPTION OF THE INVENTION

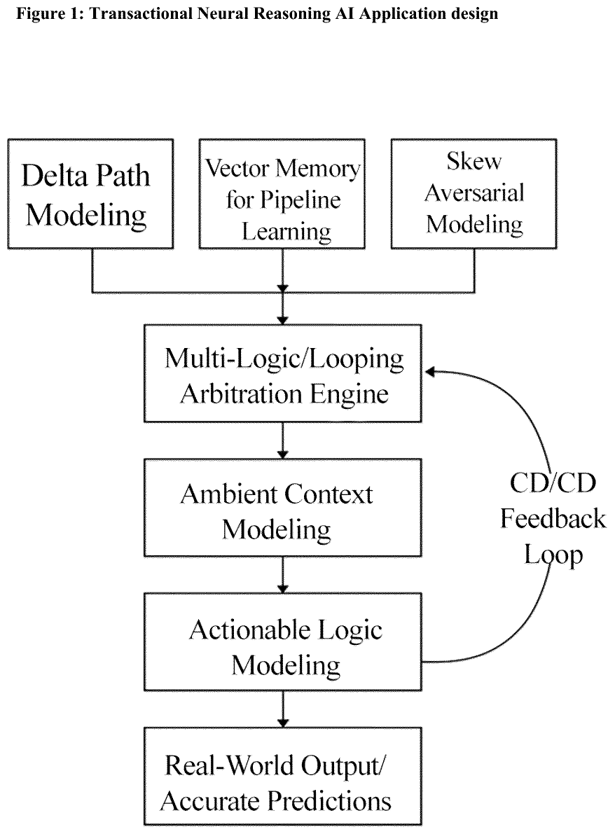

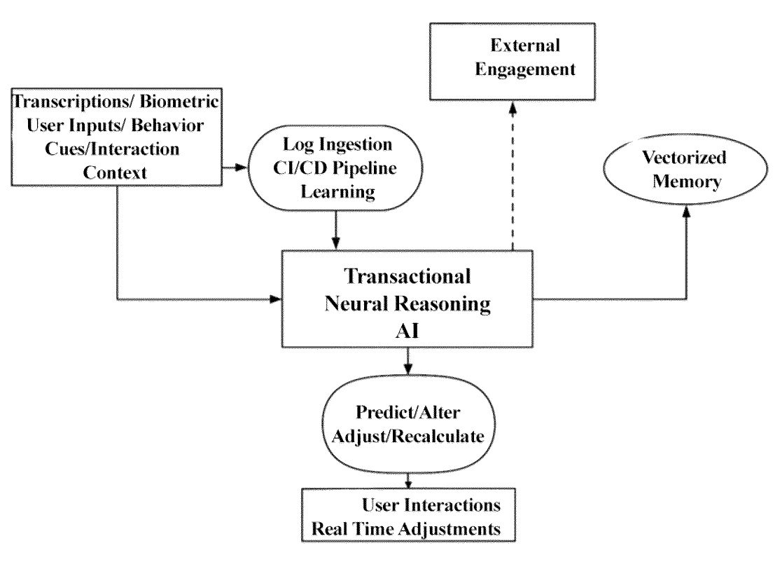

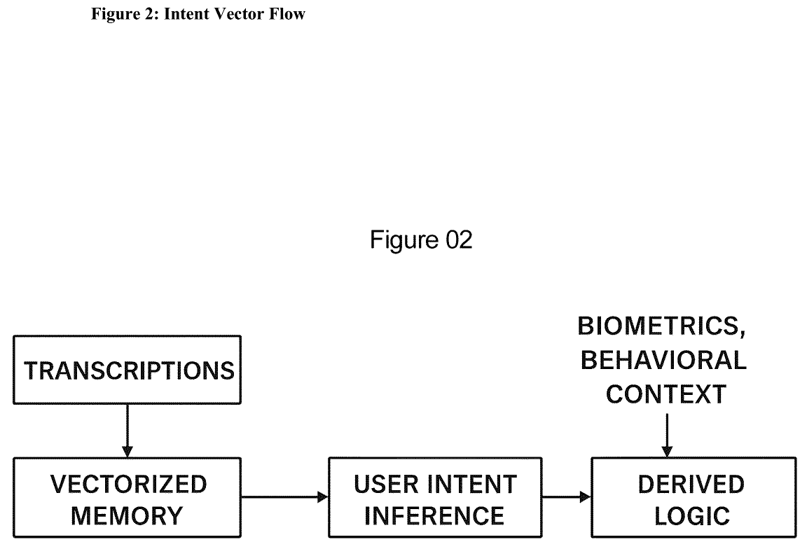

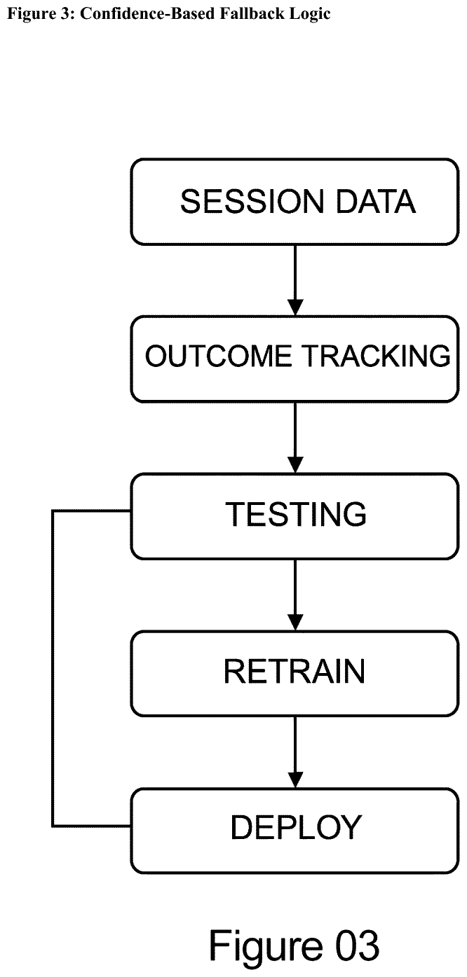

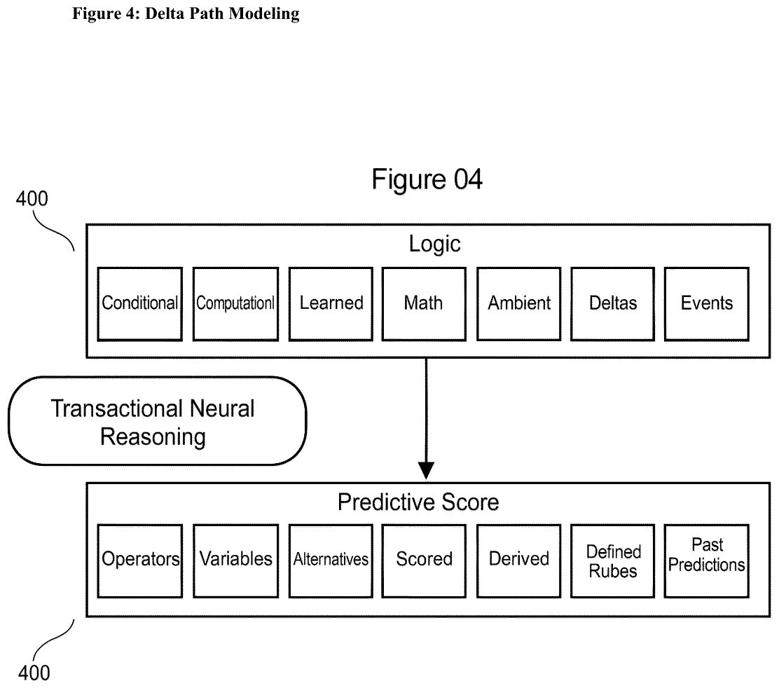

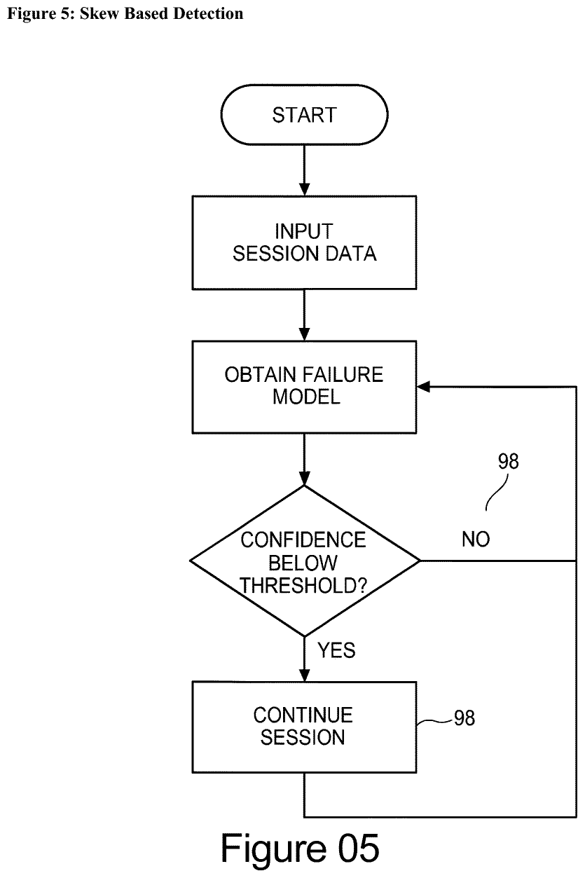

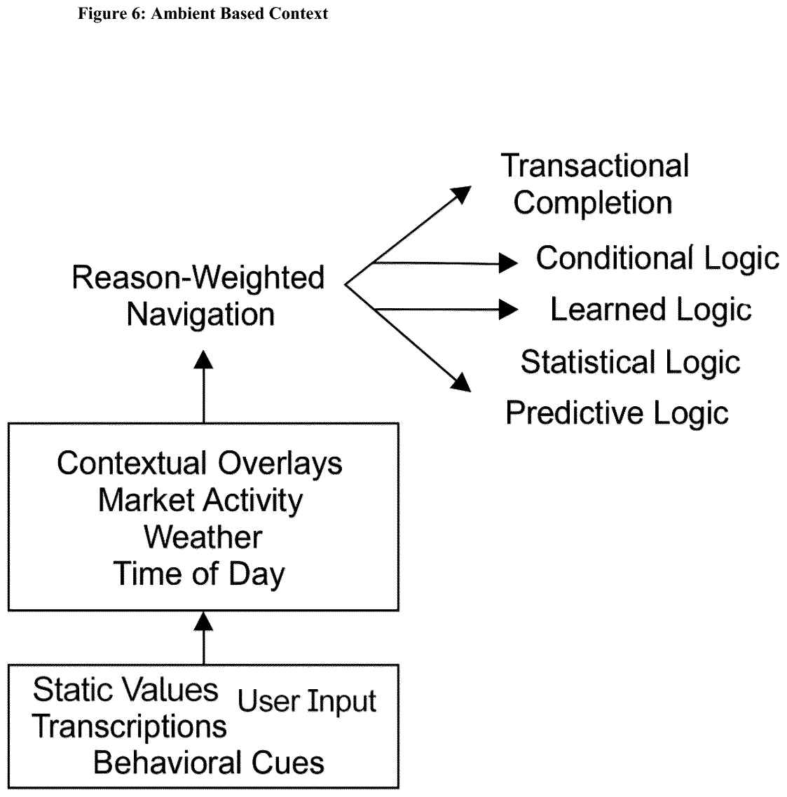

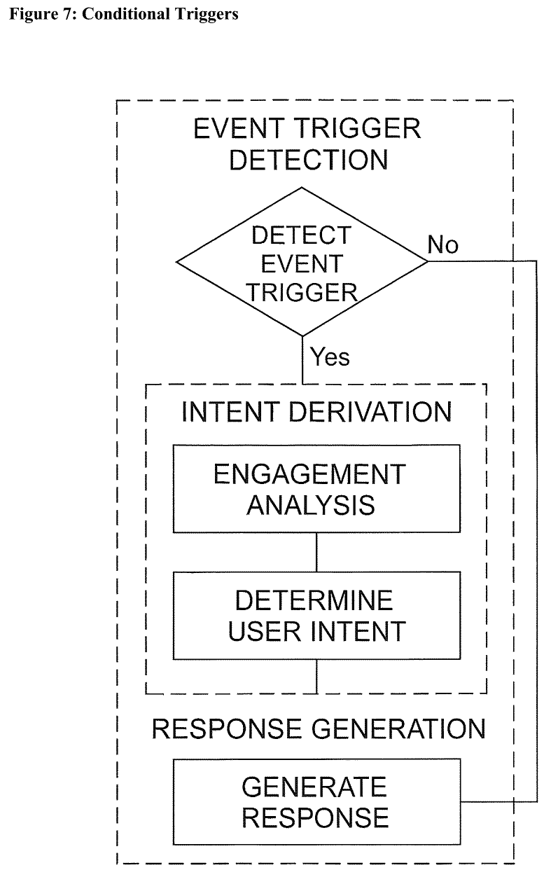

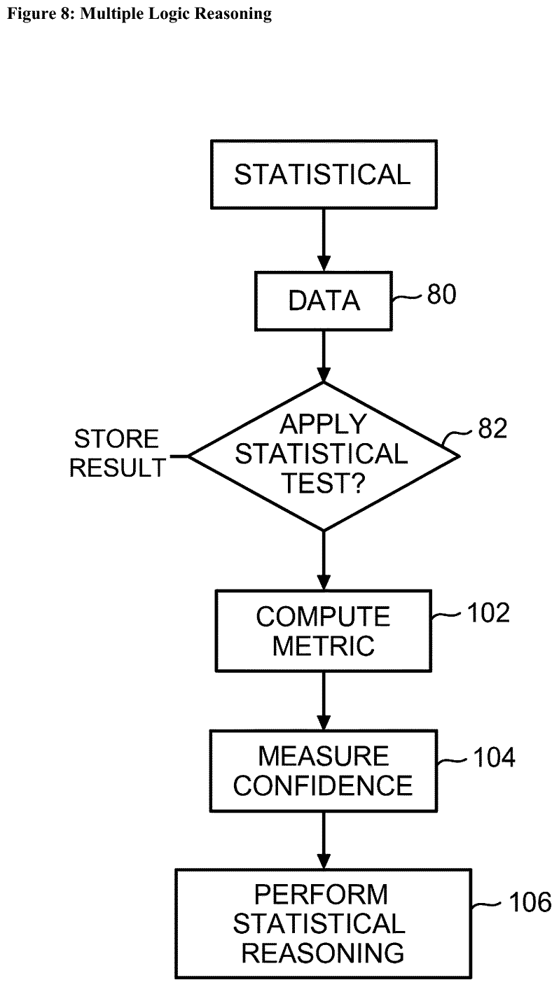

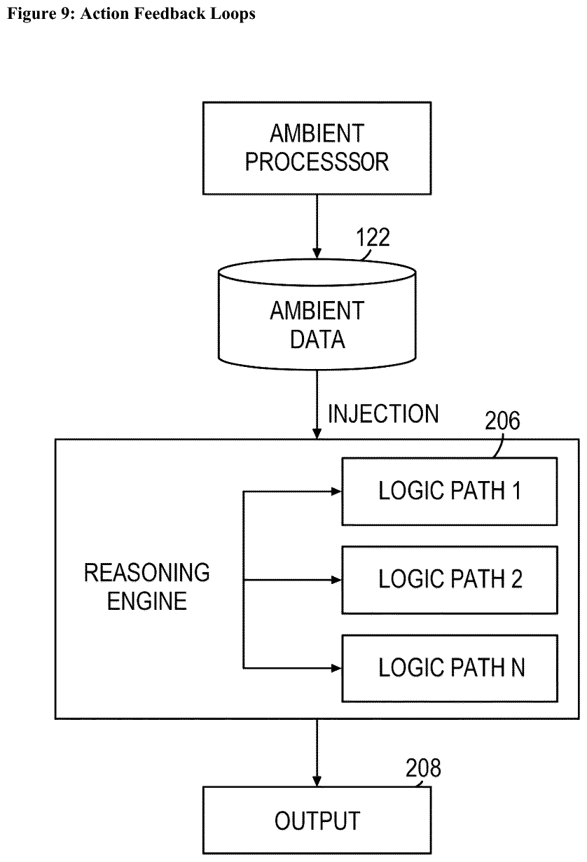

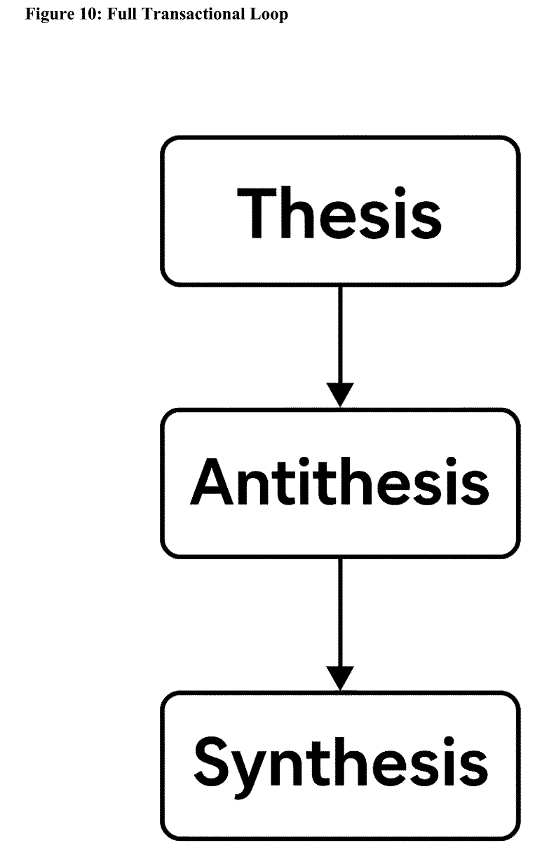

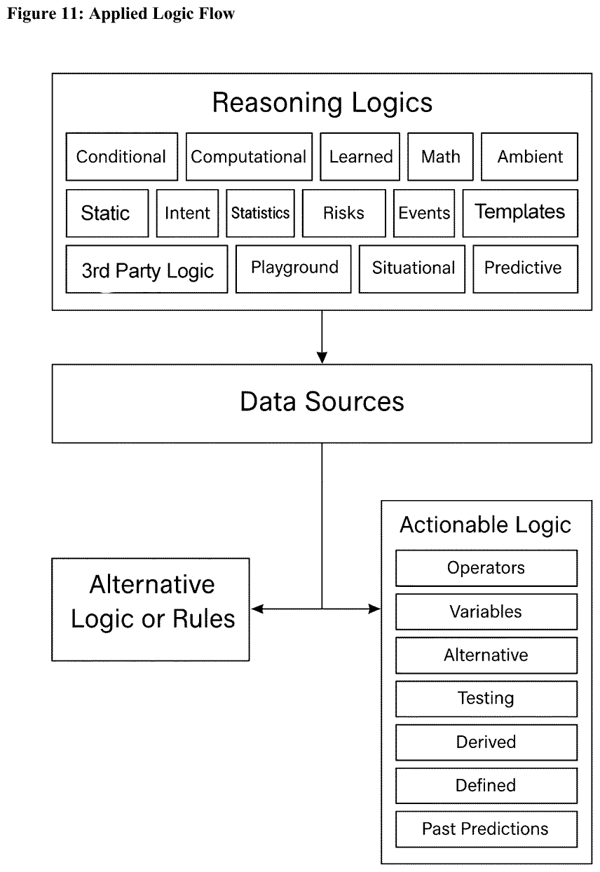

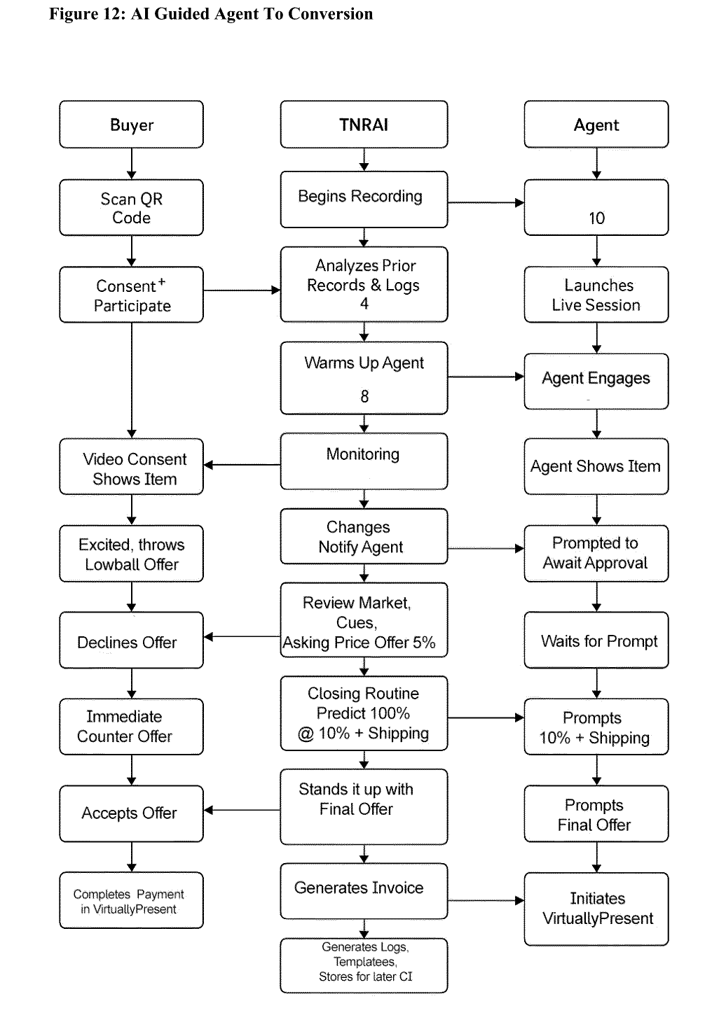

System Architecture: Referring to FIG. 1, the TNRAI system 100 comprises a set of interconnected modules that collectively perform transactional reasoning. These modules can be implemented in software, hardware, or a combination (e.g., microservices in a cloud environment orchestrating the TNRAI logic). The main components are: Vector Memory Module (110): This module receives Direct Interaction Data 111 from user sessions (e.g., live chat messages, voice transcripts, clicks, sensor readings), as well as queries a Historical Data Store 112 for relevant past records about the user or similar sessions. It also monitors Behavioral Signals 113 such as user hesitation, tone, or rapidity of actions. Module 110 encodes this information into one or more numeric vector representations. In one embodiment, it uses deep learning models to embed the current dialog state and recent history into a fixed-length intent vector. The vector memory may function akin to a vector database of session context, allowing similarity searches and retrieval of past patterns. For example, if a user has interacted before, the system can retrieve a stored embedding of that user's typical behavior to inform the current session. The output of module 110 is a real-time intent vector (or set of vectors) that summarizes what the user is trying to accomplish, continuously updated as new inputs arrive.

This vector not only captures the explicit intent (e.g., “wants to book a flight” vs “asking a question about billing”) but also nuances like emotional state or urgency if available. By using a vectorized memory, the system preserves context across multiple modalities and time—something not achieved by prior single-turn intent classifiers.

Continuous Integration/Continuous Deployment (CI/CD) Pipeline (120): Module 120 represents the automated pipeline for testing and deploying updates to TNRAI's models and rules. It interfaces with incoming data and feedback results 121 from the Actionable Logic Engine (150) to perform outcome testing. For instance, as each session concludes, it logs whether the outcome was successful or not (did the user achieve their goal?). Pipeline 120 may include a Model Testing environment 122 where new versions of the Intent derivation model, or the outcome prediction models, are evaluated using recent session data. It can perform techniques like shadow mode evaluation (running new models in parallel without affecting the live decision) or incremental rollout. A Continuous Training component 123 can trigger retraining of certain sub-models (like the ideal path or skew models) using accumulated new data.

Once a candidate update proves to improve performance metrics (for example, higher success rate or faster resolution), a Deployment Manager 124 pushes the update to the live environment, effectively updating TNRAI's logic on the fly. This pipeline ensures TNRAI does not remain static; instead, it is self-evolving. Notably, this occurs during operation—unlike conventional systems that might retrain offline and deploy periodically, TNRAI's pipeline is an integral, always-on part of the architecture.

Delta-Based Ideal Path Model (130): This component generates outcome predictions based on comparing current session progress to an ideal outcome scenario or “Gold Standard” dataset. Internally, it may utilize a library of Ideal Paths 131—sequences of events or behaviors that historically led to successful outcomes for similar contexts. For a given session, model 130 selects or constructs an ideal path (e.g., the optimal series of steps for the user to complete a purchase). It then computes Delta Metrics 132 by measuring differences between the session's actual path and the ideal path. Such differences could include missing steps, extra unnecessary steps, time delays, or out-of-sequence actions. These delta metrics are fed into a predictive algorithm that estimates the likelihood of success or failure if the session continues its current trajectory. For example, if key steps that are normally present in a successful session are absent so far, the model may predict a low success probability, prompting the system to intervene (perhaps by guiding the user to those steps or offering a coupon). The delta-based model thus provides a continuously updated gauge of outcome, essentially answering, “Are we on track to achieve the goal, and if not, how far off are we?” Skew-Based (Adversarial) Model (140): Running in parallel is module 140, trained specifically on negative or challenging scenarios designed to lead to failure. It contains an Adversarial Pattern Repository 141 of known failure modes—such as fraudulent behaviors, user inputs that often lead to dead-ends, or misleading cues that have tricked simpler models in the past. The skew model monitors the session data and intent vectors to detect any resemblance to these patterns.

If the current session starts to match a known problematic pattern (for instance, a user providing contradictory information, or a potential bot/spam input in a chat), this model raises an alert or adjusts the confidence scores downward. In essence, module 140 provides a “second opinion” focused on what could go wrong. It outputs an Adversarial Risk Score 142 or a set of flags indicating detected issues. TNRAI can use this information to become more cautious e.g., require additional verification steps, or choose a safer action. By having a dedicated adversarial reasoning component, TNRAI is more resilient to anomalies and less likely to be fooled by inputs that would cause a normal intent model to err. This skew-based model is continuously updated via the CI/CD pipeline as new failure patterns are discovered, keeping the defensive knowledge current. Ambient Context Processor (160): Module 160 ingests Ambient Data 161 from external sources unrelated to the user's direct input. Examples include: current time/date, the user's geolocation (if known) and local weather or news, system load and network latency, IoT sensor data in the environment, or even aggregate trends (such as “many users in this region are asking similar questions today”), sports season, top ten sitcoms, political factors, lunar cycles, or any form of data that is not directly related to the existing data construct but when introduced as an overlay will affect the outcome. The processor normalizes and filters this data to identify contextual factors that might influence its reasoning. It produces:

Context Signals 162 that are fed into both the Reasoning Engine and the outcome models. For instance, a context signal could be “lateNight=true” if the local time is after midnight, which the reasoning engine might interpret by prioritizing shorter, more direct interactions (assuming the user is tired or the business is closed). Or a signal could be a weather alert that causes TNRAI to adopt a more empathetic tone. These ambient signals act as additional features in the decision process, effectively adding a layer of situational awareness to TNRAI. Prior art systems might incorporate one or two such factors (e.g., location-based suggestions), but TNRAI can handle multiple context inputs and dynamically decide which are relevant via its reasoning logic, and by using its multimodal logic abilities in session, seemingly benign data becomes high value business intelligence that no one else is capable of producing because they do not have the algorithmic capabilities of the TNRAI engine.

Reasoning Engine (170): This is the core logic orchestrator of TNRAI. The engine 170 consists of multiple Logic Units 171a-171f, each implementing a different reasoning strategy (additional units may be employed as required and programmed for the purpose and implemented through the API):
171a Conditional Logic Unit: Implements rule-based reasoning (if X then Y). It evaluates any deterministic rules applicable to the session (some rules may be predefined by operators, others learned). For example, a rule might be “IF user intent=password reset AND user not authenticated, THEN require two-factor verification”.
171b Mathematical/Computational Unit: Handles numeric computations or formula-based logic. It might calculate a trust score, add up a series of values, or perform threshold checks (e.g., compare a risk score against a reward outcome).
171c Statistical Inference Unit: Applies probabilistic models, such as Bayesian inference or machine-learned classifiers, on the session data. This unit might use the output of a neural network or a Bayesian network to infer things like user intent probabilities, or likely next user action.
171d Ambient Analysis Unit: Interprets the signals from the Ambient Context Processor (160). For instance, given context flags, it might adjust internal parameters or include context-specific facts (like “store is closed now”).
171e Situational Unit: Focuses on the dynamic state of the ongoing session (the “situation”). This could include how long the session has gone on, how frustrated the user might be (derived from sentiment or repetition), or how many steps remain in the known process. It uses this to reason about urgency or pacing (e.g., if the session is dragging, it might suggest escalation).
171f Historical Pattern Unit: Retrieves patterns or cases from past sessions that is has stored as a template in the database and is called when there are key patterns that match the current session, and can suggest actions that worked in those historical cases (akin to case-based reasoning and actions to potentially avoid. These templates and patterns are associated with specific scenarios which would only be callable when a scenario meeting one of the criteria is present. Example would be a PSTN call>Inbound to the system>Mobile User>Tmobile>Dialing a number across a trunk named “Sometrunk” Destined for Joe Customer. Then score the rest of the call values, talk time, agent, engagement, speech patterns, breathing irregularity, etc. . . . .

The Reasoning Engine (170) takes inputs from the Vector Memory (110), the Ambient Processor (160), and the outputs of the outcome models (130 and 140). Each logic unit 171a-f processes the input in its own manner. The engine then aggregates or arbitrates between their outputs using a Reasoning Orchestration Logic 172. The orchestration may assign different weights to different units depending on context. For example, in a highly regulated transaction, the Conditional Logic (rules) might take precedence to ensure compliance, whereas in a more open-ended help session, the Statistical Inference might dominate to interpret the user's needs. Then there are variables which are globally assigned, can be weighted by the Ais owner and used as last resort, priority based, or contextual/conditional weights when no other logical conclusion can be derived. With a well defined set of variables calculated for all potential favorable outcomes, and all possible outcomes of failure, the logic engine can reasonably deduce a path to success based on past decision making and data at hand. The result of the Reasoning Engine's work is a Decision Set 173—which can include an interpreted intent, recommended next action, predicted outcome if that action is taken, and alternative options if applicable. Importantly, the reasoning engine can also generate explanations for its conclusions by tracing which logic units contributed (a feature helpful for legal defensibility and transparency).

Conditional Event Trigger Engine (180): As part of or alongside the reasoning engine is a trigger mechanism 180 that monitors certain conditions and thresholds. It uses the Decision Set and raw signals to decide if any predefined triggers should fire. Triggers can be thought of as instantaneous rules that cause an event in the system. Examples include: Confidence Trigger—if the confidence in the inferred intent falls below, say, 50%, trigger an “ask clarification” event; Anomaly Trigger—if the Skew Risk Score from module 140 exceeds a threshold, trigger a security challenge or alert; Goal Achieved Trigger—if an outcome prediction from module 130 is very high (meaning the user is essentially confirmed to achieve the goal), trigger an automatic completion or upsell suggestion. These triggers may bypass or expedite parts of the normal flow. They are defined by either the system designers or learned from experience. The Trigger Engine 180 ensures that TNRAI can react immediately to certain critical conditions rather than waiting for the entire reasoning cycle. It essentially interjects when specific logic patterns are matched or when vector-derived scores cross preset boundaries.

This component differentiates TNRAI from systems that operate in a strictly sequential decision loop without interrupts.

Actionable Logic Engine (150): The final component is responsible for taking action based on the reasoning outcomes. The Actionable Logic Engine 150 receives a Decision Set 173 (and any triggers 180 that fired). It then consults Action Rules Base 151 and an Operator Guidelines Database 152. The Action Rules Base may contain templates for actions (e.g., responses to user, workflow executions) and guardrails (e.g., do not perform certain actions without human approval). Operator Guidelines 152 might include business-specific policies or fallbacks defined by administrators (for instance, always transfer to a human agent if the user asks to cancel their account). Using these resources, engine 150 selects or formulates the best Action 153 to take. This could be: sending a message or prompt to the user, executing an API call to fulfill a transaction, logging the user out for security, etc. In some cases, the Actionable Engine might prepare multiple options (especially if uncertainty is high) and then either choose one based on additional quick tests or present options to a human operator for final say.

A key feature of the Actionable Logic Engine is that it validates and tests predictions before fully committing. For example, if the reasoning engine strongly predicts an outcome, the action engine might do a brief verification like checking one more piece of information or asking a confirming question to the user i.e., an operator-defined alternative step. This ensures that mistakes can be caught before irreversibly acting (important for high-stakes transactions). Once an action is taken, the outcome (success, failure, user reaction, etc.) is fed back via the feedback loop 121 into the CI/CD Pipeline (120) and also recorded in the Historical Data (112). Over time, this means the system's memory and models improve. Notably, some prior systems combined rule-based actions with predictive models (e.g., routing a call using both rules and model outputs), but TNRAI's action engine extends this by dynamically generating new rules from its reasoning and by learning from each action's result in a closed loop.

Operational Example: To illustrate TNRAI in action, consider a user interacting with an intelligent customer service system powered by TNRAI. The user begins a chat session about a billing issue. The Vector Memory (110) immediately retrieves the user's past purchase and support history, and starts vectorizing the new chat messages. The reasoning engine (170) identifies the user's intent as possibly “dispute a charge” with about 70% confidence from the statistical unit, but the conditional logic unit finds a rule that if a dispute is about a large amount, extra verification is needed. Ambient processor (160) notes it's a weekend (context), which might affect available options. The ideal path model (130) knows the optimal resolution usually involves gathering evidence and offering a refund or explanation within 10 minutes. The session so far is on track, but the skew model (140) flags that the user's phrasing resembles a known scam pattern (maybe the user is using form letters known from fraud). This lowers the overall confidence and triggers the Conditional Event Trigger (180) to require an identity verification event.

TNRAI thus asks the user to verify some details (action engine 150 executing this prompt). The user complies, which lowers the skew risk. Now the reasoning engine confirms the intent as genuine. The ideal path model says time is running longer than optimal, so perhaps escalate. The actionable engine decides to expedite a refund approval action according to business policy (because the user provided verification and it's likely a valid dispute). It executes an API call to process the refund and sends a confirmation to the user—that's the final Action 153. The session ends successfully. TNRAI logs that outcome: dispute resolved, refund issued, user verified after prompt. The CI/CD pipeline (120) takes this log and will incorporate the pattern (legitimate dispute with initially suspicious language that got resolved after verification) into future training—possibly updating the skew model to be a bit less sensitive to that language when verification is present, and updating rules in the action engine to ask for verification in such cases. This scenario shows how TNRAI interweaves multiple reasoning threads (intent understanding, rule checking, fraud detection, timing optimization) and uses a trigger to handle a risk, ultimately taking a context-appropriate action, all in one continuous flow.

Distinctiveness: TNRAI's architecture and operation are distinguishable from known AI systems in that it merges learning and reasoning in real time. It does not rely solely on a monolithic AI model (as many end-to-end deep learning systems do), but instead employs a modular reasoning strategy with transparent logic units. This makes it more explainable and adjustable—qualities often required for enterprise use and legal compliance. At the same time, it is not a fixed rule engine; it learns and adapts like a machine learning system, but at a pace and granularity much finer than traditional periodic retraining. Every session is an opportunity for both immediate optimal decision-making and for learning. By having ideal and adversarial models side by side, TNRAI also ensures a balanced approach—pursuing positive outcomes while guarding against negative ones.

The integration of ambient context is another point of novelty. While context-aware AI exists, TNRAI's use of ambient signals as just another input to a unified reasoning engine (as opposed to a separate contextual filter or pre-processing step) is unique. This means context is considered at the same decision layer as user intent and rules, yielding more nuanced decisions that neither purely rule-based nor purely statistical systems can achieve.

From a patentability perspective, each of these components and their interactions contribute to the inventive concept of TNRAI. In the claims that follow, various combinations of these features are defined to delineate the scope of the invention. Key inventive concepts include: the real-time vector memory for intent (Claim 1), the continuous integration of outcome feedback (Claim 1 and Claim 3), the dual-model outcome prediction (Claim 1, Claim 4, Claim 5), ambient data integration in reasoning (Claim 1 and Claim 6), conditional triggers (Claim 1 and Claim 7), multi-logic reasoning engine (Claim 1 and Claim 8), and the actionable logic feedback loop (Claim 1 and Claim 9). Each claim is supported by this detailed description and is intended to be interpreted in light of the examples and explanations provided herein.

1. A transactional artificial intelligence system A transactional artificial intelligence system configured to simulate human-like deliberation during live user sessions, the system comprising:
(a) a vector memory module configured to encode and retrieve high-dimensional vector representations of user behavior, historical interaction patterns, and session context in real time;
(b) a delta-based modeling engine operatively coupled to the vector memory module and configured to compute a deviation between a current session trajectory and a predefined ideal outcome path, the deviation being used to adjust confidence scores or engagement strategies;
(c) a skew-based adversarial detection module configured to compare live session data against a corpus of known failure modes, fraudulent patterns, or contradictory behaviors, and to generate risk-weighted scores that inform logic prioritization;
(d) an ambient context ingestion module configured to process environmental signals not directly provided by the user, including but not limited to time, location, system load, device state, or public event metadata, and to inject said contextual overlays into decision pathways;
(e) a multi-logic arbitration engine configured to evaluate concurrent outputs from multiple logic engines, the logic engines comprising:
(i) a conditional rule logic engine;
(ii) a statistical inference engine;
(iii) a situational analysis engine;
(iv) an ambient analysis engine; and
(v) a historical pattern recognition engine;
(f) an actionable logic engine operatively connected to the arbitration engine and configured to determine and execute next actions or engagement steps based on the synthesized decision output, the actions comprising:
(i) automated system responses;
(ii) workflow progression or escalation;
(iii) decision logging for audit or compliance; and
(iv) rule refinement or model feedback; and
(g) a continuous integration and feedback pipeline configured to monitor outcome success or failure metrics and dynamically retrain, test, and redeploy internal models, logic rules, or path mappings based on aggregated session data;
wherein the system is configured to operate in real time across multimodal user interfaces and to continuously evolve its decision-making logic in response to observed session behavior and external context, thereby simulating human-like transactional reasoning.

2. —Vector Memory for Session Recall The system of claim 1, wherein the vector memory module stores and retrieves session data as high-dimensional vectors in a vector database, enabling the system to recall and utilize past interaction contexts when interpreting current user inputs.
Relevant Prior Art:
U.S. Pat. No. 10,346,307B2—“Generating user intent vectors for NLP pipelines”
US20210293548A1—“Behavioral modeling in user sessions”
US20170350896A1—“Dynamic profiling using embeddings”
Comparative Analysis:
U.S. Pat. No. 10,346,307B2 teaches creation of user intent vectors for downstream use in NLP inference engines, but these vectors are static outputs, not actively updated during a live session. TNRAI's system instead creates persistent, evolving vector memory, acting as a session-bound context source, queried in real time by multiple logic systems.
US20210293548A1 discusses behavioral modeling through vectorized user profiles. However, this system is behaviorally anchored and retrospective, built for profiling rather than decision-state influence. TNRAI uses vector memory as an active reasoning substrate, enabling in-the-moment logic routing and evaluation.
US20170350896A1 introduces embeddings used for personalization within chatbot sessions. These embeddings are ephemeral and session-isolated, with no persistent vector recall or cross-session influence. TNRAI, by contrast, creates a retrievable, evolving memory store, referenced across sessions and learning pipelines.
Novelty Assessment:
The cited prior art uses vector embeddings primarily as passive representational artifacts. None disclose or suggest the use of real-time, session-aware vector memory that is actively updated, queried, and used to drive reasoning in an AI decision engine. TNRAI diverges from these static models by making vector memory a dynamic and central reasoning layer, forming a live, evolving memory store integrated into transactional logic and cross-session recall.
Novelty and Non-Obviousness Statement:
Whereas the cited references disclose vector embeddings as static or session-limited representations used primarily for downstream processing, behavioral profiling, or temporary personalization the present invention instead provides a persistent, high-dimensional vector memory architecture that evolves throughout and across user sessions. This vector memory is not an endpoint artifact but a central reasoning substrate, continuously updated and actively referenced in real time by the system's decision logic. The ability to retrieve, compare, and adapt logic paths based on live vector embeddings is neither taught nor suggested in the cited art. Accordingly, the claimed invention introduces a material and non-obvious improvement to session-based AI reasoning under 35 U.S.C. § § 102 and 103.

2. Continuous Integration Pipeline with Session-Linked Feedback Deployment The system of claim 1, wherein the continuous integration pipeline comprises an automated testing framework that evaluates new or modified intent prediction models and logic rules on live session data and automatically deploys updates upon determining improved outcome performance.
Relevant Prior Art:
US20190265955A1—“Automated deployment of ML models”
U.S. Pat. No. 10,817,377B2—“Managing model updates in AI systems”
US10909091B2—“Lifecycle orchestration of machine learning logic”
Comparative Analysis:
US20190265955A1 describes a system for automating the deployment of machine learning models. However, its deployment triggers are based on development pipeline events, not on outcome performance observed in real-time user interactions. There is no integration with per-session results as a metric for triggering deployment.
U.S. Pat. No. 10,817,377B2 outlines a framework for managing versions of AI models and updating those models across environments. This reference emphasizes staged updates, typically managed offline, with little or no linkage to actual inference outcomes occurring in the field during live user interactions.
US20190265955B2 discusses orchestrating AI lifecycle stages, including automated retraining and deployment. However, like the others, it relies on aggregated performance metrics, such as A/B testing or offline evaluation, rather than live user outcomes tied to real-time model testing as part of a reasoning system.
Novelty Assessment:
While machine learning CI/CD pipelines are known, they are generally activated through developer or system-level events, and focus on testing performance metrics using retrospective datasets. TNRAI introduces a novel pipeline that operates as part of the live inference engine itself, continually evaluating the performance of models and logic rules in response to ongoing session results, and immediately deploying updated versions where performance gains are observed. This tight coupling between session state and model lifecycle is not taught or suggested by the cited references.
Novelty and Non-Obviousness Statement:
Whereas the cited references disclose automated deployment and lifecycle tools for machine learning models based on offline analysis or static performance thresholds, the present invention instead provides a continuous integration pipeline that is intrinsically linked to live session outcomes. The pipeline autonomously evaluates candidate logic models in the context of actual user interactions, deploying updates dynamically when improved performance is observed in real-time. This direct feedback loop between session-level outcomes and model deployment is neither anticipated nor suggested by the art, and constitutes a novel and non-obvious advancement in adaptive AI systems under 35 U.S.C. § § 102 and 103.

3. Delta-Based Ideal Path Modeling The system of claim 1, wherein the delta-based ideal path model defines an optimal sequence of interactions for a given intent and computes a delta metric indicating a difference between the user's current interaction sequence and said optimal sequence, the delta metric being used to predict a likelihood of achieving a desired outcome or to identify when to intervene.
Relevant Prior Art:
US20220089313A1—“Goal path inference systems”
U.S. Pat No. 10,891,689B2—“User journey prediction using probabilistic models”
Comparative Analysis:
US20220089313A1 proposes systems for determining the best user path to achieve a goal using AI models, but the invention focuses on identifying likely routes based on historic data. It does not compute or act upon real-time deviations from a known optimal path during an ongoing session, nor does it use such deviation metrics to influence predictive or corrective logic.
U.S. Pat. No. 10,891,689B2 describes predicting user behavior by modeling probabilistic paths through a decision space. However, this system lacks an architectural element that defines an ideal path as a fixed or adaptive reference point, nor does it evaluate delta metrics between current behavior and that reference as part of active session management.
Novelty Assessment:
TNRAI introduces a live inference model that defines an ideal interaction sequence—based on intent and historical success—and uses this as a real-time comparator against actual user actions. The calculated delta is used to either predict session outcome confidence or trigger corrective interventions. This approach creates a real-time control system layered on top of behavioral prediction, enabling guidance rather than just forecasting. The use of a delta between actual and ideal interaction paths as a logical control mechanism is not disclosed or suggested in the cited references.
Novelty and Non-Obviousness Statement:
Whereas the cited references disclose techniques for predicting user behavior based on historical path patterns or probabilistic models, the present invention instead provides a real-time system for calculating deviation from a defined ideal interaction sequence. The system computes a delta metric during active sessions and uses this metric to influence predictive confidence or logic routing. This methodology transforms behavioral prediction into interactive path correction, a feature not anticipated or rendered obvious by the prior art. Accordingly, the invention constitutes a novel and non-obvious advancement in adaptive reasoning and session control under 35 U.S.C.

4. Skew-Based Adversarial Pattern Detection During Inference The system of claim 1, wherein the skew-based adversarial model is an adversarially trained component that monitors the interaction for patterns analogous to historically recorded failures or deceptive inputs, and upon detecting a threshold similarity to such a pattern, adjusts the reasoning engine's confidence or triggers a protective action.
Relevant Prior Art:
US20200028971A1—“Adversarial detection in AI systems”
US20180302628A1—“Adversarial robustness for NLP models”
U.S. Pat. No. 10,460,207B2—“Resilient decision systems for edge cases”
Comparative Analysis:
US20200028971A1 provides a mechanism for detecting adversarial examples during input processing and alerting the system to potential anomalies. However, this detection is used to flag input irregularities, not to actively influence the reasoning confidence of an AI logic engine mid-session.
US20180302628A1 describes defenses against adversarial inputs in NLP applications. The countermeasures are incorporated into the training process rather than operating as an active parallel monitor during runtime reasoning. These models do not maintain live adversarial detection or make real-time adjustments to inference pathways.
U.S. Pat. No. 10,460,207B2 focuses on creating AI systems that are robust to edge cases through model architecture tuning and pre-deployment simulation. It does not employ a dedicated sub-model to observe, compare, and alter the inference trajectory of an active session in response to suspected deception or failure-mode similarity.
Novelty Assessment:
TNRAI introduces a live, parallel adversarial inference model the skew model that monitors session progression in real time for alignment with historically known failure or deception patterns. This sub-model does not replace primary logic, but contributes by adjusting trust levels, reducing confidence in certain outputs, or triggering failsafe logic. The existence of a co-reasoning adversarial sub-engine monitoring live sessions and directly affecting the inference path represents a fundamental departure from static robustness training, making it a novel structural and functional component.
Novelty and Non-Obviousness Statement:
Whereas the cited references disclose adversarial detection primarily during offline training or as static input validation layers, the present invention instead provides a runtime skew-based model that continuously monitors the session for failure signatures and influences the primary reasoning engine's behavior. This adversarial engine functions as a co-processor to the main logic, dynamically adjusting confidence or triggering fallback procedures. No known art discloses or suggests this dual-inference model architecture for live session management. Accordingly, the claimed invention constitutes a non-obvious improvement in AI robustness and transactional reasoning under 35 U.S.C. § § 102 and 103.

5. Ambient Context Injection for Situational Reasoning The system of claim 1, wherein the ambient context module adjusts at least one parameter of the reasoning engine based on external contextual data selected from temporal cues, weather or environmental conditions, geolocation data, or local events, so that the system's decisions incorporate indirect situational awareness.
Relevant Prior Art:
U.S. Pat. No. 10,977,412B2—“Contextual AI using environmental cues”
US20170220960A1—“Ambient-aware assistant systems”
U.S. Pat. No. 10,650,001B2—“Location-aware inference engines”
Comparative Analysis:
U.S. Pat. No. 10,977,412B2 discloses AI systems that tailor responses based on ambient data such as time of day or weather conditions. However, these inputs are applied as filters or modifiers to content selection, not as logic-bearing influences on a reasoning engine's internal structure or thresholds.
US20170220960A1 proposes an assistant that uses ambient context to improve user experience through adjustments to output content or interface behavior. It does not involve multi-logic reasoning or permit context to dynamically affect AI inference flow or model selection.
U.S. Pat. No. 10,650,001B2 includes mechanisms for AI systems to change responses based on geolocation or environmental state, but focuses on permissions and access control rather than influencing the structure or output of the reasoning engine itself.
Novelty Assessment:
TNRAI's ambient context module is structurally integrated into its multi-logic reasoning engine and directly modulates inference weights, decision thresholds, or logic pathway selection in real time. Rather than serving as a filter or UI modifier, the ambient signals are first-class citizens in the reasoning process. This allows decisions to reflect indirect situational awareness, meaningfully shaping the AI's behavior even when user inputs remain unchanged. No prior art demonstrates such depth of integration between environmental data and real-time AI logic flow.
Novelty and Non-Obviousness Statement:
Whereas the cited references disclose ambient context systems that personalize outputs or adjust surface-level behavior based on environmental factors, the present invention instead injects ambient data directly into the reasoning core, altering logic thresholds and decision paths. This approach transforms contextual data from passive modifiers into active agents of decision-making, a feature not taught or suggested in the art. Accordingly, the claimed invention provides a novel and non-obvious advancement in context-aware reasoning under 35 U.S.C. § § 102 and 103.

6. Conditional Trigger Engine for Real-Time Flow Modification The system of claim 1, wherein the conditional trigger engine is configured to initiate a secondary process or event when an internal confidence score falls outside a specified range or when a predefined logic rule condition is met during the reasoning process, said event comprising at least one of: prompting the user for clarification, switching to an alternate decision strategy, escalating the session to a human operator, or executing a mitigating action.
Relevant Prior Art:
U.S. Pat. No. 10,755,290B2—“Confidence-based suppression systems for AI outputs”
U.S. Pat. No. 10,248,916B1—“Threshold-driven logic in NLP agents”
U.S. Pat. No. 10,810,704B2—“Interrupt-based AI response management”
Comparative Analysis:
U.S. Pat. No. 10,755,290B2 describes systems that suppress output when confidence is low. This mechanism functions as a binary gate to prevent delivery of unreliable answers but does not offer multi-path decisioning or escalation when thresholds are crossed.
U.S. Pat. No. 10,248,916B1 implements confidence scoring to determine if AI agents should ask follow-up questions, but does not include broader logic switching, mitigation, or escalation strategies. It is narrowly scoped to clarification prompts, not systemic flow adaptation.
U.S. Pat. No. 10,810,704B2 introduces interrupt-based controls that halt AI actions when predefined limits are breached, typically for fail-safe operation. However, these interrupts terminate processes rather than redirect them dynamically to alternate strategies.
Novelty Assessment:
TNRAI's conditional trigger engine enables multi-faceted event handling based on internal metrics like confidence scores or pattern detection. Rather than suppressing or halting responses, the system modifies its reasoning process mid-session, shifting to alternative strategies, prompting for clarification, or triggering escalation paths. This design allows adaptive continuity rather than interruption, offering a flexible, real-time adjustment framework absent from the cited references.
Novelty and Non-Obviousness Statement:
Whereas the cited references disclose static confidence gating, clarification-only prompts, or emergency process suppression, the present invention instead provides a conditional trigger mechanism that proactively redirects logic, switches reasoning strategies, or escalates sessions in real time based on threshold criteria. This dynamic modulation of session flow in response to internal diagnostic signals is not disclosed in prior art. Accordingly, the claimed invention introduces a novel and non-obvious control mechanism for adaptive session reasoning under 35 U.S.C. § § 102 and 103.

7. Multi-Logic Reasoning Engine with Unified Output Arbitration The system of claim 1, wherein the multi-logic reasoning engine comprises at least a rule-based logic unit, a statistical inference unit, and a historical case-based logic unit operating in parallel or sequence, and wherein the engine produces a unified decision output by combining results from these heterogeneous reasoning units.
Relevant Prior Art:
U.S. Pat. No. 10,846,732B2—“Hybrid AI reasoning systems”
U.S. Pat. No. 10,372,991B2—“Chained logic frameworks for decision systems”
US20190005359A1—“Layered inference models with fallback logic”
Comparative Analysis:
U.S. Pat. No. 10,846,732B2 describes AI systems capable of switching between logic types (e.g., rule-based and statistical), but only one logic engine is active at a time. The system does not evaluate multiple reasoning paths concurrently or merge their outcomes.
U.S. Pat. No. 10,372,991B2 teaches sequential fallback mechanisms where logic layers are chained—typically starting with deterministic logic and falling back to probabilistic inference. However, it lacks a mechanism to synthesize concurrent outputs into a unified decision, relying instead on cascading default logic.
US20190005359A1 introduces inference architectures that select among models using static criteria, such as performance or load balancing. These systems select which model to trust, not how to integrate distinct reasoning outcomes in real time.
Novelty Assessment:
TNRAI's engine allows simultaneous operation of multiple logic paradigms—deductive, statistical, and experiential—and uses a unified arbitration layer to combine their outputs into a singular decision. This design avoids the rigidity of fallback hierarchies or exclusive selection. Instead, it creates a logic consensus process that yields more robust, explainable, and adaptable inference outcomes, especially during uncertainty or conflicting signals. Such parallel, heterogeneous logic fusion is absent in known systems.
Novelty and Non-Obviousness Statement:
Whereas the cited references disclose systems that either switch between logic types or fall back to alternative strategies based on failure or performance thresholds, the present invention instead provides a unified reasoning engine in which rule-based, statistical, and case-based logics operate concurrently or in orchestrated sequence. Their outputs are actively fused by a coordination layer to form a single, arbitrated decision. This structure enables higher fidelity inference and greater fault tolerance and is not taught or suggested by any known art. Accordingly, the claimed invention satisfies the statutory requirements of novelty and non-obviousness under 35 U.S.C. § § 102 and 103.

8. Actionable Logic Engine with Real-Time Feedback-Based Rule Refinement The system of claim 1, wherein the actionable logic engine further comprises a feedback interface that records the outcome of each executed action and updates one or more decision rules or model parameters if the outcome deviates from an expected result, thereby refining future action selections.
Relevant Prior Art:
US20210212789A1—“Self-improving AI assistants with feedback loops”
U.S. Pt. No. 10,467,351B2—“Action tuning using result-based reinforcement”
US20180261165A1—“Interactive retraining in conversational AI systems”
Comparative Analysis:
US20210212789A1 outlines the use of logs and long-term metrics to improve assistant performance over time. However, its improvement mechanisms are post-session and batch-processed, not live or action-linked. It does not update logic rules during the same user interaction cycle.
U.S. Pat. No. 10,467,351B2 applies reinforcement learning to gradually adjust AI responses based on long-term reward signals. These systems lack a deterministic, rule-oriented logic layer that can be re-weighted or edited based on immediate outcome deviation.
US20180261165A1 teaches model retraining through supervised review of session transcripts, which then informs future deployments. However, it omits any in-session real-time refinement of the action execution logic or rule base, especially in closed-loop deployments.
Novelty Assessment:
TNRAI introduces an inference-time feedback loop directly embedded within the logic engine. When an executed action diverges from the predicted or intended result, the system immediately adjusts rules or model parameters to optimize future decisioning—even within the same operational context. This capability to refine logic in real time, based on immediate session outcomes, distinguishes TNRAI from passive learning and long-horizon feedback systems. The result is an AI engine that actively learns by doing—without requiring retraining or external triggers.
Novelty and Non-Obviousness Statement:
Whereas the cited references disclose delayed or batch-based feedback mechanisms that inform AI models over time, the present invention instead provides a real-time feedback interface embedded within the actionable logic engine. This mechanism records the success or failure of each action, and actively refines decision rules or parameters on the fly, without requiring retraining or offline processing. No known art teaches or suggests such immediate, session-based rule adaptation. Accordingly, the claimed invention represents a novel and non-obvious advancement in intelligent systems under 35 U.S.C. § § 102 and 103.

9. Method for Transactional Neural Reasoning with Real-Time Feedback and Adaptive Logic A computer-implemented method for transactional neural reasoning using an AI system, the method comprising:
(a) collecting interaction data from a user session and retrieving related historical context;
(b) generating an intent vector from the collected data that encapsulates the user's probable intent;
(c) predicting an outcome of the session via concurrently evaluating an ideal outcome path and known adversarial patterns against the session data;
(d) incorporating ambient context information into the evaluation by adjusting decision parameters based on external conditions;
(e) reasoning across multiple logic domains by applying rule-based checks, statistical inference, and historical pattern matching to the intent vector and context to determine a recommended action;
(f) triggering a conditional event during said reasoning if a confidence or pattern criterion is met, to modify the flow of interaction;
(g) executing an action responsive to the recommended action using an actionable logic engine; and
(h) updating the AI system's models or rules in real time by feeding back the outcome of the action and the session into a continuous integration pipeline, such that future iterations of steps (b)-(g) are improved.
Relevant Prior Art:
U.S. Pat. No. 10,248,916B1—“Decision engines with reactive trigger modules”
U.S. Pat. No. 10,846,732 B2—“Hybrid reasoning systems”
U.S. Pat. No. 10,467,351B2—“Action tuning based on reinforcement signals”
US20210212789A1—“Self-improving digital assistants”
Comparative Analysis:
U.S. Pat. No. 10,248,916B1 teaches using confidence scores to affect conversation flow in NLP systems, but does not combine adversarial logic, ambient context, or multi-logic arbitration in a single workflow. It also lacks real-time system learning via outcome feedback.
U.S. Pat. No. 10,846,732B2 describes switching between reasoning models but does not include logic fusion, vector memory, or contextual deltas. The models operate in isolation and lack unified adaptation mechanisms.
U.S. Pat. No. 10,467,351B2 and US20210212789A1 rely on reinforcement learning and post-session feedback aggregation, without any real-time adjustment to logic models, delta path evaluation, or simultaneous adversarial reasoning.
Novelty Assessment:
TNRAI's method is a closed-loop, adaptive reasoning framework that processes multimodal input, calculates session-specific deltas, evaluates logic concurrently across multiple domains, injects situational data, and immediately refines future reasoning through continuous model integration. This coordinated interaction of subsystems—across steps (a) through (h)—is not shown in any prior reference as a unified process. TNRAI transforms the reasoning session into an evolving event with learning, logic modulation, and ambient awareness all occurring in the same pipeline
Novelty and Non-Obviousness Statement:
Whereas the cited references disclose partial workflows involving intent classification, logic switching, or feedback aggregation, the present invention instead provides an integrated method comprising real-time session data capture, adaptive intent modeling, delta-based reasoning, ambient-aware logic fusion, conditional interruption, action execution, and immediate feedback-based rule optimization. This holistic pipeline enables continuous improvement within the same engagement context and is not taught, suggested, or rendered obvious by any single reference or combination thereof. Accordingly, the claimed method constitutes a novel and non-obvious advancement in transactional AI reasoning under 35 U.S.C. § § 102 and 103.
